(19) United States
(12) Patent Application Publication
(10) Pub. No.: US 2026/0168847 A1
(43) Pub. Date: Jun. 18, 2026

(54) HIGH-SPATIAL-RESOLUTION SOLAR IMAGER BASED ON OPTICAL INTERFERENCE AND OPERATING METHOD THEREFOR

(71) Applicant: Shanghai Institute of Technical Physics, Chinese Academy of Sciences, Shanghai (CN)

(72) Inventor: Qinghua YU, Shanghai (CN)

(21) Appl. No.: 19/292,805

(22) Filed: Aug. 6, 2025

(30) Foreign Application Priority Data
Dec. 13, 2024 (CN) 202411834161.0

(51) Int. Cl. G01J 1/42; G01J 1/02; G01J 1/04

(52) U.S. Cl. CPC G01J 1/42; G01J 1/0214; G01J 1/0252; G01J 1/0425; G01J 1/0429; G01J 2001/4266

(57) ABSTRACT

A high-spatial-resolution solar imager based on optical interference and an operating method are provided. The imager comprises a high-aperture-filling-density aperture pair array, a heat dissipation system, a broadband beam single-mode fiber transmission array, a fast phase scanning modulation and compensation module, a narrowband beam splitting/filtering system, a narrowband beam single-mode fiber transmission array, an integrated orthogonal polarization measurement device array, a photoelectric conversion and data acquisition unit, and a data processing and image reconstruction unit. The aperture pair array is adopted for energy collection, measures cross-correlation intensity information of spatial frequency spectra of solar light through interferometric paired optical fiber transmission, and then reconstructs high-spatial-resolution solar image through algorithm. The imager effectively overcomes defects of large-aperture aggregation schemes comprising beam distortion, high-energy convergence, and stray light interference in a large-aperture range, and has advantages of strong expandability, low development costs, and the like in high-spatial-resolution solar imaging.

### CROSS-REFERENCE TO RELATED APPLICATIONS

The subject application claims priority on Chinese Patent Application No. CN202411834161.0 filed on Dec. 13, 2024 in China. The contents and subject matter of the Chinese priority application are incorporated herein by reference in the entirety.

### TECHNICAL FIELD

The present invention relates to the technical field of optoelectronic imaging, and in particular to a high-spatial-resolution solar imager based on optical interference and an operating method therefor. The present invention provides a new technical solution for space weather scientists and astronomers to observe and study the sun.

### BACKGROUND ART

Acquiring high-spatial-resolution observation data of the sun is of great significance for predicting the future destiny of human beings. Firstly, the sun is the dominant entity in the solar system that influences all spheres of the Earth, and understanding solar dynamics helps human beings to live easefully and comfortably on the Earth. Secondly, the sun is the only star that human beings can observe profoundly, and studying characteristics of stellar changes through solar observations helps to deepen human understanding of cosmic formation and evolution, which is of significant practical significance and value for safeguarding international livelihood and national security, promoting the future development of human beings, and searching for extraterrestrial civilizations.

Over the past 400 years, human beings have conducted extensive research in the above fields and established more than 60 solar observatories worldwide. In recent years, scientists have made tremendous efforts to acquire high-definition solar image data and achieve precise forecasting of solar activities. Currently, basic methods used to acquire high-definition images are all based on diffraction imaging principles and fall into two categories: limited-aperture detection instruments arranged in launched satellites, as represented by the U.S. “Parker” Solar Probe, are used to observe the sun at close proximity but have the defects of high costs, extreme thermal constraints, short service life, etc.; and ground-based large-aperture detection instruments, as represented by the U.S. 4.24-meter Daniel K. Inouye Solar Telescope (DKIST) and the 8-meter Advanced Ground-based Solar Telescope being designed in process in China, employ traditional single-aperture technical solutions to improve the solar resolution by increasing optical apertures but have a series of defects such as optical jamming caused by high-intensity energy harvesting, degradation of seeing angle caused by atmospheric turbulence, etc.

Additionally, the 8-meter Advanced Ground-based Solar Telescope is theoretically capable of observing solar granulation structures within an arcsecond range of only 0.1″-2.6″ (1.4″ on average, corresponding to 1,000 km) on the solar surface. Solar observation instruments with larger optical apertures are needed to observe potential finer substructures in the granulation structures. So far, no researches or reports on solar imagers with larger apertures or higher resolutions have been found.

Since the discovery of optical interference phenomena 200 years ago, optical interference technology has gradually evolved from astronomical angular measurement to astronomical computational imaging and optical interferometric computational imaging. The optical interferometric computational imaging has the primary technical advantage of ultra-high spatial resolution and has been widely applied to the field of extrasolar stellar observation. The most representative example is the Center for High Angular Resolution Astronomy (CHARA) array in the U.S., and the array is composed of six 1 m telescopes arranged in a Y shape, which enables observation of visible light and 2.2 μm infrared light. In 2006, the CHARA, in cooperation with an interferometer composed of four telescopes, captured surface images of the binary star Altair in three hours. Six years later, in 2012, scientists from the University of California, Davis, pioneered the Segmented Planar Imaging Detector for EO Reconnaissance (SPIDER) technology combining integrated optics with optical interference and experimentally validated the integrated optical interferometric computational imaging in 2016. However, there are still no research reports and ideas on the application of the technology to solar observation. Moreover, some traditional methods for constructing segmented large-aperture high-spatial-resolution observation telescopes have been described in the literature, and synthetic apertures, combined apertures, or segmented aperture, are unsuitable for solar imaging observations. For example, it is described on page 283 of the book Principles and Design of Astronomical Telescopes written by Cheng, Jingquan and published by Nanjing University Press, as follows: “Fortunately, the Webb Space Telescope is not a coronagraph, and the coronagraph necessitates use of a single primary mirror.” Therefore, the application of the optical interferometric computational imaging based on an aperture-segmented array arrangement to solar imaging observations requires further exploration.

The violent solar activity with hazardous impact on the Earth is generally referred to as a “magnetic storm,” which is an activity driven by a magnetic field. Magnetic activities are hidden in polarization characteristics of solar light, and therefore, current solar imaging technology pursues the high spatial resolution and focuses on polarized light measurements of specific spectral widths that reflect magnetic field characteristics.

The following challenges exist in the application of optical interferometric computational imaging to high-spatial-resolution solar imaging:
(1) Long-baseline transient imaging: the sun is burning fiercely all the time, and high-spatial-resolution imaging needs to be completed instantaneously, that is, a solar imager needs to capture solar light information in a timely and accurate manner at an equivalent aperture of meters or even tens of meters. Ground-based interferometric high-spatial-resolution telescopes based on optical interferometric computational imaging achieve cross-correlation intensity acquisition at high spatial-frequency sampling rates within a long baseline range over time according to relative motion positions of stars and cannot meet instantaneous imaging requirements. Thus, a technical solution of long-baseline transient imaging is needed.
(2) Transient measurement of polarization data: solar imagers of the existing technology all achieve direct imaging on diffraction image planes and measure solar magnetic fields through traditional polarization elements such as polarizers. The working principle of optical interferometric computational imaging differs from that of direct imaging on diffraction image planes. Therefore, polarization measurement methods of the existing technology cannot be directly used, and a novel multi-polarization-state transient measurement method based on optical interferometric computational imaging needs to be invented to measure the polarization intensities reflecting solar magnetic field information.
(3) Optical path difference caused by atmospheric turbulence or long baseline stability: a high-spatial-resolution imager has a larger equivalent aperture or baseline scale, and working environment vibrations or temperature field changes affect the stability of the optical path difference corresponding to the optical interference arm and further affect the accuracy of interference signal detection. Additionally, when a ground-based optical observation instrument is used for solar observations, atmospheric turbulence inevitably causes wavefront distortion of solar beams and leads to variations in the optical path difference of the interference optical path, which further affects the accuracy of interference signal detection. Therefore, for the imagers based on optical interferometric computational imaging, certain technical measures need to be taken to control or compensate for variations in interference optical path differences caused by various factors so as to enhance the accuracy of interference information measurement.
(4) Temperature field control: the solar imager faces the sun directly when working, solar beams directly illuminate the optical instrument such that heating by the solar light cannot be avoided and changes in the temperature field of optomechanical components cause thermal deformation, which affects the operating performance of the solar imager. Therefore, a heat dissipation module must be an important component of the solar imager.
(5) Stray light suppression: the high-spatial-resolution solar imager usually has a small field of view (FOV) directed at the sun when working. Solar radiation at the edge of the FOV easily enters a suppression angle of the instrument and then enters an imaging optical path as stray light, which affects the imaging quality. Particularly for the coronagraph, when the FOV is used to image the corona with relatively weak radiation, the photosphere beam with stronger radiation from the solar disk enters the coronagraph as a stray light source, which severely affects imaging. Therefore, stray light suppression must be an important factor for design of the coronagraph.

### SUMMARY OF THE INVENTION

The present invention provides a high-spatial-resolution solar imager based on optical interference that meets all the above challenges and solves the problems in the existing technology. The imager of the present invention comprises a high-aperture-filling-density aperture pair array, a heat dissipation system, a broadband beam single-mode fiber transmission array, a fast phase scanning modulation and compensation module, a narrowband beam splitting/filtering system, a narrowband beam single-mode fiber transmission array, an integrated orthogonal polarization measurement device array, a photoelectric conversion and data acquisition unit, and a data processing and image reconstruction unit. Solar light to be measured is collected by the aperture pair array, sequentially passes through the broadband beam single-mode fiber transmission array, the fast phase scanning modulation and compensation module, the narrowband beam splitting/filtering system, the narrowband beam single-mode fiber transmission array, and the integrated orthogonal polarization measurement device array, transmitted in pairs into the photoelectric conversion and data acquisition unit, then converted into electrical signals and stored, and finally processed by the data processing and image reconstruction unit for inverse reconstruction of a solar high-spatial-resolution image with two orthogonal polarization states.

In the present invention, the integrated orthogonal polarization measurement device array is composed of a plurality of integrated orthogonal polarization measurement devices; each integrated orthogonal polarization measurement device comprises two aperture-pair beam collection terminals, two 1×2 beam-splitting polarizing units, two polarization direction-x beam transmission units, two polarization direction-y beam transmission units, two same-polarization-state 2×1 beam-combining interference units, and two orthogonal polarization-state beam output terminals. Four optical paths from a starting point of beam polarization and splitting to an end point of beam combining in the integrated orthogonal polarization measurement device have a same optical path length; solar light is coupled into the aperture-pair beam collection terminal, split into two orthogonal polarized beams by the 1×2 beam-splitting polarizing units, and then transmitted through the polarization direction-x beam transmission units and the polarization direction-y beam transmission units; then, same-polarization-state beams are paired into the same-polarization-state 2×1 beam-combining interference units for interference, and finally output from the orthogonal polarization-state beam output terminal, and are subjected to photoelectric conversion for contrast measurement of the cross-correlation intensities of two orthogonal polarized light information Ix and Iy of the solar light;
in order to ensure that the solar imager works normally when directly facing the sun, the high-spatial-resolution solar imager further comprises a heat dissipation system, and the heat dissipation system is configured for temperature control of an entire imaging optical path, particularly for heat dissipation of the aperture pair array directly facing the solar light;
the broadband beam single-mode fiber transmission array employs single-mode fibers to suppress stray light through an effective numerical aperture angle of the fiber, particularly to suppress near-FOV stray light hardly suppressed with traditional solar imagers;
the fast phase scanning modulation and compensation module is configured to control an optical path difference between paired optical paths, compensate for variations in the optical path difference of an interference optical path caused by atmospheric turbulence, working environment vibrations or temperature field changes, and achieve fast scanning near a zero optical path difference between the paired optical paths through closed-loop control technology during information acquisition, so as to obtain cross-correlation intensity information of spatial frequencies with two orthogonal polarization states, where a spatial phase modulator or a fiber-stretching phase modulator (an optical fiber delay line) may be selected according to differences in an optical path compensation range and accuracy;
the narrowband beam splitting/filtering system satisfies requirements for spectral selection and filtering corresponding to scientific objectives in solar observations;
the integrated orthogonal polarization measurement device array divides a single-mode beam collected and transmitted at a front end thereof into two orthogonal polarized beams according to a polarization direction, and further achieves measurement of solar light information of two orthogonal polarization states; and
the integrated orthogonal polarization measurement device array is located between the narrowband beam single-mode fiber transmission array and the photoelectric conversion and data acquisition unit, and the integrated orthogonal polarization measurement device array completes the contrast measurement of the cross-correlation intensities of two orthogonal polarized light information Ix and Iy of the solar light.

In the present invention, the data processing and image reconstruction unit is configured for spatial frequency domain phase retrieval and image reconstruction.

For a ground-based high-spatial-resolution solar imager, the present invention employs an aperture pair array where each sub-aperture has a relatively small diameter (about millimeter-scale) such that wavefront distortion caused by atmospheric turbulence in a diameter range of each sub-aperture may be neglected. Each aperture pair baseline varies, a length of the aperture pair baseline ranges from millimeter to meter, and for any aperture pairs, especially long-baseline aperture pairs, the wavefront distortion of beam caused by atmospheric turbulence cannot be ignored. Therefore, the fast phase scanning modulation and compensation module is required to compensate for variations in the optical path difference between aperture pairs. Additionally, vibrations or temperature field changes induce relative positional deviations between any baseline-paired aperture pairs, resulting in variations in the optical path difference between the aperture pairs, such that the fast phase scanning modulation and compensation module is also required to give compensation.

In the present invention, the atmospheric turbulence does not affect a space-based high-spatial-resolution solar imager, but impacts of vibrations or temperature field changes on relative positional deviations between any baseline-paired aperture pairs cannot be avoided. Therefore, the fast phase scanning modulation and compensation module is also a core component of a high-spatial-resolution solar imager based on optical interference used for space-based observations.

In practical application, in order to utilize existing conventional single-aperture solar imagers and reduce the cost of constructing a new interference-based high-spatial-resolution solar imager, the high-aperture-filling-density aperture pair array may exclude a short-baseline interference information acquisition part, that is, a hollow portion is formed, and corresponding light collection and imaging are achieved by a single-aperture solar imager with an aperture equivalent to a short baseline. Imaging information obtained is transmitted to the data processing and image reconstruction unit, fused with data acquired by a long-baseline interference information acquisition part, and finally processed by the data processing and image reconstruction unit for inverse reconstruction of a solar high-spatial-resolution image with two orthogonal polarization states.

The present invention further provides an operating method for a high-spatial-resolution solar imager based on optical interference, and the operating method is applicable to the above high-spatial-resolution solar imager based on optical interference, comprising:
S1, powering on the solar imager, activating the fast phase scanning modulation and compensation module and the photoelectric conversion and data acquisition unit, compensating for variations in the optical path difference caused by factors such as atmospheric turbulence, working environment vibrations or temperature field changes through scanning of the fast phase scanning modulation and compensation module, acquiring a maximum value of an interference envelope of each paired transmission interference optical path of the aperture pair array through the photoelectric conversion and data acquisition unit, then determining a zero optical path difference position of each paired transmission interference optical path in each aperture pair array of the solar imager, and arranging the fast phase scanning modulation and compensation module near the zero optical path difference position of each paired transmission interference optical path of each aperture pair array;
S2, activating the fast phase scanning modulation and compensation module and the photoelectric conversion and data acquisition unit, scanning through vicinity of the zero optical path difference of each paired transmission interference optical path through the fast phase scanning modulation and compensation module of the solar imager, and recording cross-correlation intensity interference data of two orthogonal polarized light information Ix and Iy of the solar light acquired by the integrated orthogonal polarization measurement device array through the photoelectric conversion and data acquisition unit; and
S3, filtering out the direct current through the data processing and image reconstruction unit, calculating peak-to-valley values and means of cross-correlation intensity interference data of two orthogonal polarized light information Ix and Iy of solar light, obtaining contrast of cross-correlation intensities of a spatial frequency spectrum at two orthogonal polarization states, and reconstructing a solar high-spatial-resolution image through a phase retrieval and image reconstruction algorithm.

To sum up, the present invention discloses a high-spatial-resolution solar imaging method based on optical interferometric computational imaging, uses a high-aperture-filling-density aperture pair array for solar light collection, collects same into the optical fiber array for long-baseline beam transmission, then transmits same into a polarization detector array with the function of detecting two orthogonal polarization states, utilizes optical interference conditions and numerical apertures of single-mode fibers to suppress near-FOV stray light, completes transient measurement of solar polarization data through a phase difference control module and a high-speed photoelectric detector, and finally achieves inverse reconstruction of a solar high-spatial-resolution image through the algorithm.

The present invention, instead of using traditional technical solutions of direct imaging on single-aperture diffraction image planes, uses the aperture pair array for energy collection, measures cross-correlation intensity information of spatial frequency spectra of solar light through interferometric paired optical fiber transmission, and then reconstructs a high-spatial-resolution solar image through the algorithm. The present invention effectively overcomes defects of large-aperture aggregation schemes comprising beam distortion, high-energy convergence, and stray light interference in a large-aperture range, and has advantages of strong expandability, low development costs, and the like in high-spatial-resolution solar imaging.

The present invention solves the above-mentioned problem of long-baseline transient imaging by aperture arrangement of imagers based on optical interferometric computational imaging, such as those of a checkerboard imager in CN202010965700.X filed on Sep. 15, 2020 (which corresponds to US2023/0185021A1), a SPIDER in U.S. Pat. No. 8,913,859B1 published on Dec. 16, 2014, both references are incorporated herein by reference, or a honeycomb imager, employs a high-aperture-filling-density aperture pair array to collect solar light, collects same into an optical fiber array with the long-distance transmission capability and achieves paired transmission of aperture pair beams through optical fibers. The present invention achieves high-density sampling of solar light information in a spatial frequency domain and a long baseline range and minimizes information loss caused by aperture segmentation, i.e., achieving transient acquisition of solar light information in a long baseline range. As optical path instability in optical beam transmission through optical fibers poses challenges to phase measurement of spatial frequency cross-correlation intensity based on optical interference measurement, a phase retrieval algorithm (e.g., On Fienup Methods for Sparse Phase Retrieval, Digital Object Identifier 10.1109/TSP.2017.2780044) is introduced to reconstruct solar images.

To solve the second problem of transient measurement of polarization data, the present invention, instead of SPIDER's integrated optical 2D waveguide orthogonal modulation coupler array, uses an integrated orthogonal polarization measurement device array and integrates an aperture-pair beam-paired transmission fiber array to measure solar light polarization data. Each integrated orthogonal polarization measurement device comprises two aperture-pair beam collection terminals, two 1×2 beam-splitting polarizing units, two polarization direction-x beam transmission units, two polarization direction-y beam transmission units, two same-polarization-state 2×1 beam-combining interference units, and two orthogonal polarization-state beam output terminals. Four optical paths from a starting point of beam polarization and splitting to an end point of beam combining in the integrated orthogonal polarization measurement device have a same optical path length. Solar light is coupled into the aperture-pair beam collection terminal, split into two orthogonal polarized beams by the 1×2 beam-splitting polarizing units, and then transmitted through the polarization direction-x beam transmission units and the polarization direction-y beam transmission units. Then, same-polarization-state beams are paired into the same-polarization-state 2×1 beam-combining interference units for interference, and finally output from the orthogonal polarization-state beam output terminal.

To solve the third problem of optical path difference caused by atmospheric turbulence or long baseline stability, the present invention configures a fast phase scanning modulation and compensation module for an optical path of beam transmission in the aperture-pair beam-paired transmission fiber array to control an optical path difference of each pair of paired transmission optical fibers and achieves compensation for variations in the optical path difference of an interference optical path caused by atmospheric turbulence and working environment vibrations or temperature field changes, thereby ensuring accurate measurement of cross-correlation intensities of solar light with different polarization states and different spatial spectra.

To solve the fourth problem of temperature field control, the present invention employs an aperture pair array for energy collection and achieves independent energy collection through each sub-aperture, which avoids high-density energy concentration at a single point in a large aperture range and reduces an energy density. Additionally, the present invention uses a thermal conduction heat dissipation method for temperature field control of the aperture pair array and the entire imager, thereby ensuring a relatively stable temperature field environment for imaging.

To solve the fifth problem of stray light suppression, the present invention adopts single-mode fibers for energy collection, and achieves 100% suppression of energy outside a field of view (FOV) based on working aperture characteristics of single-mode fibers. Moreover, as stray light does not meet interference conditions, stray light as part of direct current is filtered during extraction of interference signals.

### BRIEF DESCRIPTION OF THE DRAWINGS

FIG. 1 shows the structure of the high-spatial-resolution solar imager based on optical interference in the present invention.

FIG. 2 shows the structure of the integrated orthogonal polarization measurement device in the present invention.

FIG. 3 shows an image of a solar surface input by simulation in Example 1, where the image is selected from images acquired by a visible broadband imager (VBI) of a Daniel K. Inouye Solar Telescope (DKIST) funded by National Science Foundation of the United States.

FIG. 4 is a reconstructed image of a solar surface output by simulation in Example 1, where a solar imager N=60, a minimum baseline length Bmin=0.0036 mm, and a maximum baseline length Bmax=0.2175 m.

FIG. 5 is a reconstructed image of a solar surface output by simulation in Example 1, where a solar imager N=260, a minimum baseline length Bmin=0.0036 mm, and a maximum baseline length Bmax=0.9360 m.

FIG. 6 illustrates a single-aperture and long-baseline interferometric high-spatial-resolution solar imager in Example 1, comprising a traditional single-aperture solar imager, and a solar imager based on optical interference without a short baseline.

FIG. 7 illustrates a simulation result of imaging through a high-spatial-resolution solar imager in Example 2.

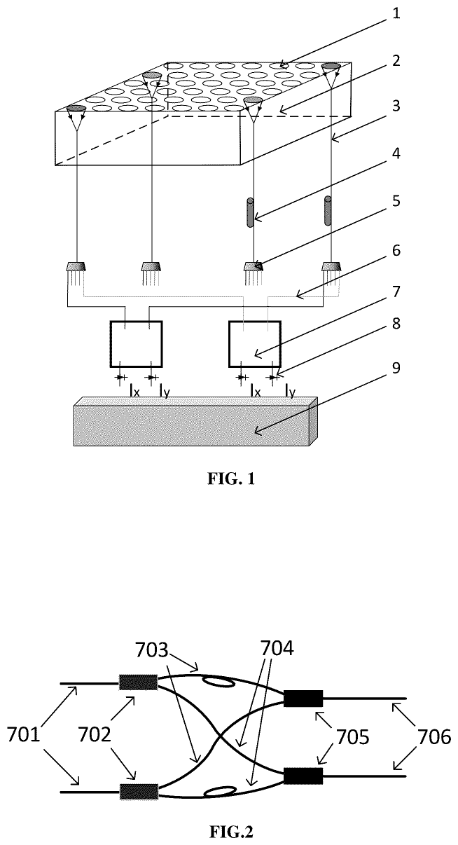

Reference numerals in the figures refer to the following structures: 1. aperture pair array; 2. heat dissipation system; 3. broadband beam single-mode fiber transmission array; 4. fast phase scanning modulation and compensation module; 5. narrowband beam splitting/filtering system; 6. narrowband beam single-mode fiber transmission array; 7. integrated orthogonal polarization measurement device array; 701. aperture-pair beam collection terminal; 702. 1×2 beam-splitting polarizing unit; 703. polarization direction-x beam transmission unit; 704. polarization direction-y beam transmission unit; 705. same-polarization-state 2×1 beam-combining interference unit; 706. orthogonal polarization-state beam output terminal; 8. photoelectric conversion and data acquisition unit; 9. data processing and image reconstruction unit; 10. traditional single-aperture solar imager; and 11. hollow portion.

### DETAILED DESCRIPTION OF THE INVENTION

The present invention is further described below with reference to specific embodiments. It should be understood that these examples are merely illustrative of the present invention and are not intended to limit the scope of the present invention. Additionally, it should be understood that after reading the content disclosed herein, those skilled in the art can make various modifications or alterations to the present invention, and these equivalent forms fall within the scope defined by the appended claims of the present invention.

### Example 1: Ground-Based High-Spatial-Resolution Solar Imager

In Example 1, a high-spatial-resolution solar imager based on optical interference (such as a ground-based high-spatial-resolution solar imager) is provided. The high-spatial-resolution solar imager comprises a high-aperture-filling-density aperture pair array 1, a heat dissipation system 2, a broadband beam single-mode fiber transmission array 3, a fast phase scanning modulation and compensation module 4, a narrowband beam splitting/filtering system 5, a narrowband beam single-mode fiber transmission array 6, an integrated orthogonal polarization measurement device array 7, a photoelectric conversion and data acquisition unit 8, and a data processing and image reconstruction unit 9, where solar light to be measured is collected by the aperture pair array 1, sequentially passes through the broadband beam single-mode fiber transmission array 3, the fast phase scanning modulation and compensation module 4, the narrowband beam splitting/filtering system 5, the narrowband beam single-mode fiber transmission array 6, and the integrated orthogonal polarization measurement device array 7, transmitted in pairs into the photoelectric conversion and data acquisition unit 8, then converted into electrical signals and stored, and finally processed by the data processing and image reconstruction unit 9 for inverse reconstruction of a solar high-spatial-resolution image with two orthogonal polarization states, and the heat dissipation system 2 provides a stable temperature field environment for each group of components.

The integrated orthogonal polarization measurement device array 7 is composed of a series of integrated orthogonal polarization measurement devices, and each integrated orthogonal polarization measurement device comprises two aperture-pair beam collection terminals 701, two 1×2 beam-splitting polarizing units 702, two polarization direction-x beam transmission units 703, two polarization direction-y beam transmission units 704, two same-polarization-state 2×1 beam-combining interference units 705, and two orthogonal polarization-state beam output terminals 706. Four optical paths from a starting point of beam polarization and splitting to an end point of beam combining in the integrated orthogonal polarization measurement device have the same optical path length; solar light is coupled into the aperture-pair beam collection terminal 701, split into two orthogonal polarized beams by the 1×2 beam-splitting polarizing units 702, and then transmitted through the polarization direction-x beam transmission units 703 and the polarization direction-y beam transmission units 704; then, same-polarization-state beams are paired into the same-polarization-state 2×1 beam-combining interference units 705 for interference, and finally output from the orthogonal polarization-state beam output terminal 706, and are subjected to photoelectric conversion for contrast measurement of the cross-correlation intensities of two orthogonal polarized light information Ix and Iy of the solar light.

The heat dissipation system 2 is configured for temperature control of an entire imaging optical path, particularly for heat dissipation of the aperture pair array 1 directly facing the solar light. The broadband beam single-mode fiber transmission array 3 employs single-mode fibers to suppress stray light through an effective numerical aperture angle of the fiber, particularly to suppress near-FOV stray light. The fast phase scanning modulation and compensation module 4 is configured to control an optical path difference between paired optical paths and compensate for variations in the optical path difference of an interference optical path caused by atmospheric turbulence, working environment vibrations or temperature field changes, and achieve fast scanning near a zero optical path difference between the paired optical paths through closed-loop control technology during information acquisition, so as to obtain cross-correlation intensity information of spatial frequencies with two orthogonal polarization states, where a spatial phase modulator or a fiber-stretching phase modulator (an optical fiber delay line) may be selected according to differences in an optical path compensation range and accuracy. The narrowband beam splitting/filtering system 5 satisfies requirements for spectral selection and filtering corresponding to scientific objectives in solar observations. The integrated orthogonal polarization measurement device array 7 divides a single-mode beam collected and transmitted at a front end thereof into two orthogonal polarized beams according to a polarization direction, and further achieves measurement of solar light information of two orthogonal polarization states.

The integrated orthogonal polarization measurement device array 7 is located between the narrowband beam single-mode fiber transmission array 6 and the photoelectric conversion and data acquisition unit 8, and the integrated orthogonal polarization measurement device array 7 completes the contrast measurement of the cross-correlation intensities of two orthogonal polarized light information Ix and Iy of the solar light.

The data processing and image reconstruction unit 9 is configured for spatial frequency domain phase retrieval and image reconstruction.

The present invention provides an operating method for a high-spatial-resolution solar imager based on optical interference that is applicable to the above high-spatial-resolution solar imager based on optical interference. The method comprises the following steps:
S1, power on the solar imager, activate the fast phase scanning modulation and compensation module 4 and the photoelectric conversion and data acquisition unit 8, compensate for variations in the optical path difference caused by factors such as atmospheric turbulence, working environment vibrations or temperature field changes through scanning of the fast phase scanning modulation and compensation module 4, acquire a maximum value of an interference envelope of each paired transmission interference optical path of the aperture pair array 1 through the photoelectric conversion and data acquisition unit 8, then determine a zero optical path difference position of each paired transmission interference optical path in each aperture pair array 1 of the solar imager, and arrange the fast phase scanning modulation and compensation module 4 near the zero optical path difference position of each paired transmission interference optical path of each aperture pair array 1;
S2, activate the fast phase scanning modulation and compensation module 4 and the photoelectric conversion and data acquisition unit 8, scan through vicinity of the zero optical path difference of each paired transmission interference optical path through the fast phase scanning modulation and compensation module 4 of the solar imager, and record cross-correlation intensity interference data of two orthogonal polarized light information Ix and Iy of the solar light acquired by the integrated orthogonal polarization measurement device array through the photoelectric conversion and data acquisition unit 8; and
S3, filter out the direct current through the data processing and image reconstruction unit 9, calculate peak-to-valley values and means of cross-correlation intensity interference data of two orthogonal polarized light information Ix and Iy of solar light, obtain contrast of cross-correlation intensities of a spatial frequency spectrum at two orthogonal polarization states, and reconstruct a solar high-spatial-resolution image through a phase retrieval and image reconstruction algorithm.

According to the above technical solution, the high-spatial-resolution solar imager based on optical interference (the ground-based high-spatial-resolution solar imager) employs a rectangular aperture pair array arrangement scheme of a checkerboard imager (see ZL201711000143.2) to achieve continuous non-redundant sampling in a maximum baseline scale range, and system parameters are shown in the following table. Single-mode polarization-maintaining fibers are adopted, a polarization direction of an optical fiber array is aligned with a polarization direction x of an integrated orthogonal polarization measurement device array. In theory, light Ix only in the polarization direction x is collected and transmitted along an optical path, and zero light energy Iy is output in a polarization direction y.

TABLE 1
System parameters of a ground-based high-
spatial-resolution solar imaging scheme:

| Items | Parameters | |
|---|---|---|
| Operational center wavelength | 450.287 | nm |
| Operation bandwidth | 0.406 | nm |
| Aperture pair array | Checkerboard-type | |
| arrangement scheme | | |
| Minimum baseline length Bmin | 0.0036 | mm |
| Array scale | (2N + 1) × (2N + 1) | |
| Fibers for long-baseline beam | Single-mode polarization-maintaining | |
| transmission | fibers | |
| Polarization direction of | x-polarization | |
| optical fiber | | |
| Heat dissipation system | Metal as a main supporting material + | |
| | active systems such as a water cooling | |
| | system | |
| Fast phase scanning modulation | Spatial large-range phase control + | |
| and compensation module | fiber-based fine phase control | |
| Integration time | 1 | ms |

The support structure of an aperture pair array or a fiber transmission array is made of a metal material with high specific stiffness and good thermal conductivity such as invar titanium alloy. The support structure is connected to active thermal control systems such as a water cooling system to ensure structural stability and a stable temperature field for the systems. The fast phase scanning modulation and compensation module, through a combination of the spatial large-range phase control and the fiber-based fine phase control, as well as a closed-loop control circuit, achieves coarse adjustment of an optical path difference between paired aperture pair arrays in a range of +3 mm, and also high-precision fine adjustment of 20 nm within a 10 μm range in any area. Before exposure for solar surface imaging, each optical path difference position of each aperture pair array is rapidly scanned in a large optical path difference range, and then fast scanning is performed within several wavelengths of a zero optical path difference position to compensate for the optical path difference of an aperture pair interference arm caused by atmospheric turbulence and other factors. Additionally, photoelectric exposure is performed to collect and record an interference fringe of each spatial frequency corresponding to each aperture pair. Based on data of the interference fringe, contrast of cross-correlation intensities of each spatial frequency in the polarization direction x of solar light is calculated. Finally, a high-spatial-resolution image of the solar light in the polarization direction x is inversely reconstructed through a phase retrieval and image reconstruction algorithm of a data processing and image reconstruction unit.

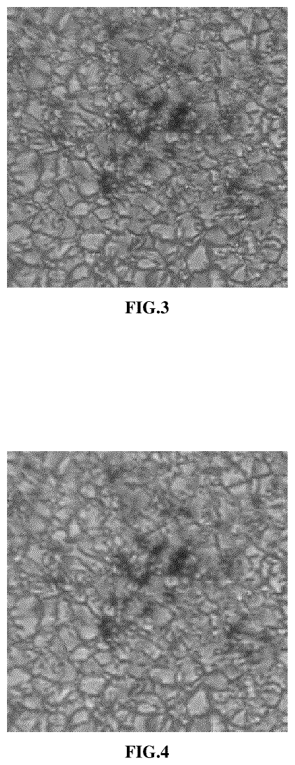

One image (shown in FIG. 3) acquired by a visible broadband imager (VBI) of a Daniel K. Inouye Solar Telescope (DKIST) funded by National Science Foundation of the United States is used as a simulation image and input into a simulation model of the imaging system. When a solar imager N=60, that is, a maximum baseline length Bmax=0.2175 m, an image inversely reconstructed is shown in FIG. 4, and when N=260, that is, a maximum baseline length Bmax=0.9360 m, an image inversely reconstructed is shown in FIG. 5.

The high-aperture-filling-density aperture pair array 1 excludes a short-baseline interference information acquisition part, that is, a hollow portion 11 is formed, and corresponding light collection and imaging are achieved by a single-aperture solar imager 10 with an aperture equivalent to that of a short-baseline solar imager, and imaging information obtained is transmitted to the data processing and image reconstruction unit 9, fused with data acquired by a long-baseline interference information acquisition part, and finally processed by the data processing and image reconstruction unit 9 for inverse reconstruction of a solar high-spatial-resolution image with two orthogonal polarization states.

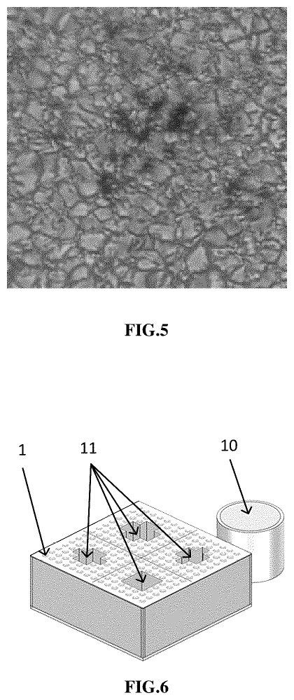

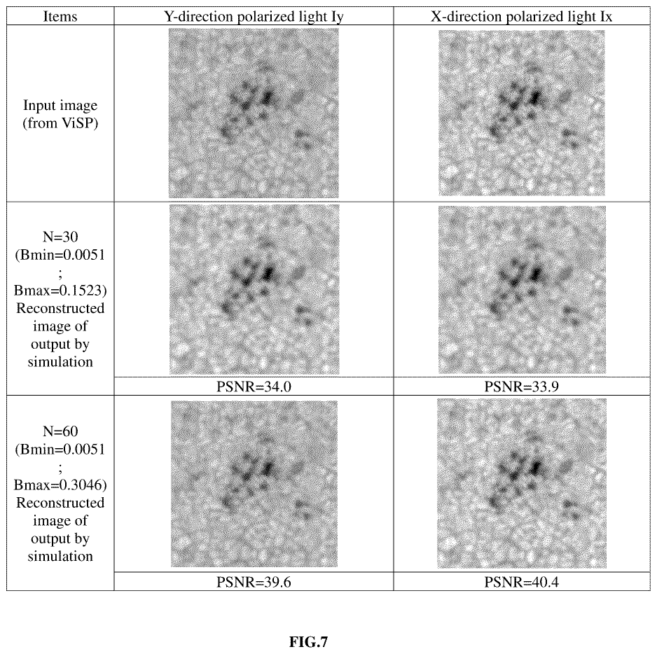

Specifically, a short-baseline solar imager may be replaced by a traditional single-aperture solar imager with an aperture equivalent to a short baseline, that is, as shown in FIG. 6, a high-spatial-resolution solar imager may be composed of a traditional single-aperture solar imager with a relatively small aperture equivalent to a short baseline, and an interferometric solar imager with a relatively long baseline. A high-aperture-filling-density aperture pair array 1 of the interferometric solar imager with a relatively long baseline in FIG. 6 excludes a short-baseline interference information acquisition part, that is, a hollow portion 11 is formed. Light collection and imaging functions of the hollow portion 11 are implemented by a single-aperture solar imager 10 with an aperture equivalent to a short baseline. Imaging data acquired by the single-aperture solar imager 10 is transmitted to a data processing and image reconstruction unit 9, fused with data acquired by the interferometric solar imager with a relatively long baseline, and finally processed by the data processing and image reconstruction unit 9 for inverse reconstruction of a solar high-spatial-resolution image with two orthogonal polarization states, with an effect equivalent to that of a long-baseline solar imager. In this example, the short-baseline solar imager with N=60 and the maximum baseline length Bmax=0.2175 m may be replaced by a traditional single-aperture solar imager with an equivalent diameter D=0.2175 m, which, in combination with an interferometric solar imager with a baseline range of 0.2175 m to 0.9360 m, achieves a same imaging effect as that of a solar imager with N=260 and the maximum baseline length Bmax=0.9360 m.

### Example 2: High-Spatial-Resolution Solar Imager

In Example 2, a high-spatial-resolution solar imager based on optical interference (such as a high-spatial-resolution solar imager) is provided. The high-spatial-resolution solar imager of the present invention comprises a high-aperture-filling-density aperture pair array 1, a heat dissipation system 2, a broadband beam single-mode fiber transmission array 3, a fast phase scanning modulation and compensation module 4, a narrowband beam splitting/filtering system 5, a narrowband beam single-mode fiber transmission array 6, an integrated orthogonal polarization measurement device array 7, a photoelectric conversion and data acquisition unit 8, and a data processing and image reconstruction unit 9, where solar light to be measured is collected by the aperture pair array 1, sequentially passes through the broadband beam single-mode fiber transmission array 3, the fast phase scanning modulation and compensation module 4, the narrowband beam splitting/filtering system 5, the narrowband beam single-mode fiber transmission array 6, and the integrated orthogonal polarization measurement device array 7, transmitted in pairs into the photoelectric conversion and data acquisition unit 8, then converted into electrical signals and stored, and finally processed by the data processing and image reconstruction unit 9 for inverse reconstruction of a solar high-spatial-resolution image with two orthogonal polarization states, and the heat dissipation system 2 provides a stable temperature field environment for each group of components.

The integrated orthogonal polarization measurement device array 7 is composed of a series of integrated orthogonal polarization measurement devices, and each integrated orthogonal polarization measurement device comprises two aperture-pair beam collection terminals 701, two 1×2 beam-splitting polarizing units 702, two polarization direction-x beam transmission units 703, two polarization direction-y beam transmission units 704, two same-polarization-state 2×1 beam-combining interference units 705, and two orthogonal polarization-state beam output terminals 706. Four optical paths from a starting point of beam polarization and splitting to an end point of beam combining in the integrated orthogonal polarization measurement device have a same optical path length; solar light is coupled into the aperture-pair beam collection terminal 701, split into two orthogonal polarized beams by the 1×2 beam-splitting polarizing units 702, and then transmitted through the polarization direction-x beam transmission units 703 and the polarization direction-y beam transmission units 704; then, same-polarization-state beams are paired into the same-polarization-state 2×1 beam-combining interference units 705 for interference, and finally output from the orthogonal polarization-state beam output terminal 706, and are subjected to photoelectric conversion for contrast measurement of the cross-correlation intensities of two orthogonal polarized light information Ix and Iy of the solar light.

The heat dissipation system 2 is configured for temperature control of an entire imaging optical path, particularly for heat dissipation of the aperture pair array 1 directly facing the solar light. The broadband beam single-mode fiber transmission array 3 employs single-mode fibers to suppress stray light through an effective numerical aperture angle of the fiber, particularly to suppress near-FOV stray light; the fast phase scanning modulation and compensation module 4 is configured to control an optical path difference between paired optical paths, compensate for variations in the optical path difference of an interference optical path caused by atmospheric turbulence, working environment vibrations or temperature field changes, and achieve fast scanning near a zero optical path difference between the paired optical paths through closed-loop control technology during information acquisition, so as to obtain cross-correlation intensity information of spatial frequencies with two orthogonal polarization states, where a spatial phase modulator or a fiber-stretching phase modulator (an optical fiber delay line) may be selected according to differences in an optical path compensation range and accuracy. The narrowband beam splitting/filtering system 5 satisfies requirements for spectral selection and filtering corresponding to scientific objectives in solar observations. The integrated orthogonal polarization measurement device array 7 divides a single-mode beam collected and transmitted at a front end thereof into two orthogonal polarized beams according to a polarization direction, and further achieves measurement of solar light information of two orthogonal polarization states.

The integrated orthogonal polarization measurement device array 7 is located between the narrowband beam single-mode fiber transmission array 6 and the photoelectric conversion and data acquisition unit 8, and the integrated orthogonal polarization measurement device array 7 completes the contrast measurement of the cross-correlation intensities of two orthogonal polarized light information Ix and Iy of the solar light.

The data processing and image reconstruction unit 9 is configured for spatial frequency domain phase retrieval and image reconstruction.

The present invention provides an operating method for a high-spatial-resolution solar imager based on optical interference that is applicable to the above high-spatial-resolution solar imager based on optical interference, comprising:
S1, power on the solar imager, activate the fast phase scanning modulation and compensation module 4 and the photoelectric conversion and data acquisition unit 8, compensate for variations in the optical path difference caused by factors such as atmospheric turbulence, working environment vibrations or temperature field changes through scanning of the fast phase scanning modulation and compensation module 4, acquire a maximum value of an interference envelope of each paired transmission interference optical path of the aperture pair array 1 through the photoelectric conversion and data acquisition unit 8, then determine a zero optical path difference position of each paired transmission interference optical path in each aperture pair array 1 of the solar imager, and arrange the fast phase scanning modulation and compensation module 4 near the zero optical path difference position of each paired transmission interference optical path of each aperture pair array 1;
S2, activate the fast phase scanning modulation and compensation module 4 and the photoelectric conversion and data acquisition unit 8, scan through vicinity of the zero optical path difference of each paired transmission interference optical path through the fast phase scanning modulation and compensation module 4 of the solar imager, and record cross-correlation intensity interference data of two orthogonal polarized light information Ix and Iy of the solar light acquired by the integrated orthogonal polarization measurement device array through the photoelectric conversion and data acquisition unit 8; and
S3, filter out the direct current through the data processing and image reconstruction unit 9, calculate peak-to-valley values and means of cross-correlation intensity interference data of two orthogonal polarized light information Ix and Iy of solar light, obtain contrast of cross-correlation intensities of a spatial frequency spectrum at two orthogonal polarization states, and reconstruct a solar high-spatial-resolution image through a phase retrieval and image reconstruction algorithm.

According to the above technical solution, the high-spatial-resolution solar imager based on optical interference (the high-spatial-resolution solar imager) employs a rectangular aperture pair array arrangement scheme of a checkerboard imager, and system parameters are shown in the following table. Single-mode fibers are adopted to collect and transmit light in the polarization directions x and y.

TABLE 2
System parameters of a high-spatial-
resolution solar imaging scheme

| Items | Parameters | |
|---|---|---|
| Operating wavelength | 629.4 | nm |
| Aperture pair array | Checkerboard | |
| arrangement scheme | | |
| Minimum baseline length | 0.0051 | mm |
| Array scale | (2N + 1) × (2N + 1) | |
| Fibers for long-baseline beam | Single-mode fibers | |
| transmission | | |
| Heat dissipation system | Metal as a main supporting material + | |
| | active systems such as a water cooling | |
| | system | |
| Integration time | 1 | ms |

| | |
|---|---|
| Polarization direction | x and y |

The support structure of an aperture pair array or a fiber transmission array is made of a metal material with high specific stiffness and good thermal conductivity such as invar titanium alloy. The support structure is connected to active thermal control systems such as a water cooling system to ensure structural stability and a stable temperature field for the systems. The fast phase scanning modulation and compensation module, through a combination of the spatial large-range phase control and the fiber-based fine phase control, as well as a closed-loop control circuit, achieves coarse adjustment of an optical path difference between paired aperture pair arrays in a range of ±3 mm, and also high-precision fine adjustment of 20 nm within a 10 μm range in any area. Before exposure for solar surface imaging, each optical path difference position of each aperture pair array is rapidly scanned in a large optical path difference range, and then fast scanning is performed within several wavelengths of a zero optical path difference position to compensate for the optical path difference of an aperture pair interference arm caused by atmospheric turbulence and other factors. Additionally, photoelectric exposure is performed to collect and record an interference fringe of each spatial frequency corresponding to each aperture pair. Based on data of the interference fringe, contrast of cross-correlation intensities of each spatial frequency in the polarization directions x and y of solar light is calculated. Finally, high-spatial-resolution images of the solar light in the polarization directions x and y are inversely reconstructed through a phase retrieval and image reconstruction algorithm of a data processing and image reconstruction unit.

Two arbitrary images in the polarization directions x and y collected by a visible spectro-polarimeter (ViSP) of a Daniel K. Inouye Solar Telescope (DKIST) funded by National Science Foundation of the United States are used as simulation images and input into a simulation model of the imaging system. When the solar imager N=30, that is, when the maximum baseline length Bmax=0.1523 m, Peak Signal-to-Noise Ratios (PSNRs) of images inversely reconstructed in the polarization directions x and y are 33.9 and 40.0 respectively; and when the solar imager N=60, that is, when the maximum baseline length Bmax=0.3046, the PSNRs of images inversely reconstructed in the polarization directions x and y are 40.4 and 39.6 respectively. See FIG. 7 for details.

PSNR is an indicator for evaluating image quality by comparing the difference between an original input image and a reconstructed image of interferometric imaging, and a higher value indicates higher fidelity of image. Simulation results of this example show that the reconstructed solar image of the high-spatial-resolution solar imager based on optical interference closely matches the input original image in fidelity, proving that the technical solution disclosed in the present invention may be applied to solar imaging observations.

The foregoing are preferred embodiments of the present invention and not intended to limit the patent scope of the present invention. Any equivalent structure or equivalent process transformation made by using the description of the present invention and the contents of the accompanying drawings, or directly or indirectly used in other related technical fields, are all similarly comprised in the scope of patent protection of the present invention.

I claim:

1. A high-spatial-resolution solar imager based on optical interference, comprising a high-aperture-filling-density aperture pair array;
a heat dissipation system;
a broadband beam single-mode fiber transmission array;
a fast phase scanning modulation and compensation module;
a narrowband beam splitting/filtering system;
a narrowband beam single-mode fiber transmission array;
an integrated orthogonal polarization measurement device array;
a photoelectric conversion and data acquisition unit; and
a data processing and image reconstruction unit,
wherein solar light to be measured is collected by the aperture pair array, sequentially passes through the broadband beam single-mode fiber transmission array, the fast phase scanning modulation and compensation module, the narrowband beam splitting/filtering system, the narrowband beam single-mode fiber transmission array, and the integrated orthogonal polarization measurement device array, transmitted in pairs into the photoelectric conversion and data acquisition unit, then converted into electrical signals and stored, and finally processed by the data processing and image reconstruction unit for inverse reconstruction of a solar high-spatial-resolution image with two orthogonal polarization states, and the heat dissipation system provides a stable temperature field environment for each group of components.

2. The high-spatial-resolution solar imager based on optical interference according to claim 1, wherein the integrated orthogonal polarization measurement device array comprises
a series of integrated orthogonal polarization measurement devices, and each integrated orthogonal polarization measurement device comprises two aperture-pair beam collection terminals, two 1×2 beam-splitting polarizing units, two polarization direction-x beam transmission units, two polarization direction-y beam transmission units, two same-polarization-state 2×1 beam-combining interference units, and two orthogonal polarization-state beam output terminals;
four optical paths from a starting point of beam polarization and splitting to an end point of beam combining in the integrated orthogonal polarization measurement device have a same optical path length, and solar light is coupled into the aperture-pair beam collection terminal, split into two orthogonal polarized beams by the 1×2 beam-splitting polarizing units, and then transmitted through the polarization direction-x beam transmission units and the polarization direction-y beam transmission units; and then, same-polarization-state beams are paired into the same-polarization-state 2×1 beam-combining interference units for interference, and finally output from the orthogonal polarization-state beam output terminal.

3. The high-spatial-resolution solar imager based on optical interference according to claim 1, wherein the heat dissipation system is configured for temperature control of an entire imaging optical path, particularly for heat dissipation of the aperture pair array directly facing the solar light; the broadband beam single-mode fiber transmission array employs single-mode fibers to suppress stray light through an effective numerical aperture angle of the fiber, particularly to suppress near-FOV stray light;
the fast phase scanning modulation and compensation module is configured to control an optical path difference between paired optical paths, compensate for variations in the optical path difference of an interference optical path caused by atmospheric turbulence, working environment vibrations or temperature field changes, and achieve fast scanning near a zero optical path difference between the paired optical paths through closed-loop control technology during information acquisition, so as to obtain cross-correlation intensity information of spatial frequencies with two orthogonal polarization states; the narrowband beam splitting/filtering system satisfies requirements for spectral selection and filtering corresponding to scientific objectives in solar observations;
the integrated orthogonal polarization measurement device array divides a single-mode beam collected and transmitted at a front end thereof into two orthogonal polarized beams according to a polarization direction, and further achieves measurement of solar light information of two orthogonal polarization states; and the data processing and image reconstruction unit is configured for spatial frequency domain phase retrieval and image reconstruction.

4. The high-spatial-resolution solar imager based on optical interference according to claim 1, wherein the high-aperture-filling-density aperture pair array excludes a short-baseline interference information acquisition part, that is, a hollow portion is formed, and corresponding light collection and imaging are achieved by a single-aperture solar imager with an aperture equivalent to that of a short-baseline solar imager; and
imaging information obtained is transmitted to the data processing and image reconstruction unit, fused with data acquired by a long-baseline interference information acquisition part, and finally processed by the data processing and image reconstruction unit for inverse reconstruction of a solar high-spatial-resolution image with two orthogonal polarization states.

5. A method for operating the high-spatial-resolution solar imager based on optical interference as described in claim 1, comprising:
S1, powering on the solar imager, activating the fast phase scanning modulation and compensation module and the photoelectric conversion and data acquisition unit, compensating for variations in the optical path difference caused by factors such as atmospheric turbulence, working environment vibrations or temperature field changes through scanning of the fast phase scanning modulation and compensation module, acquiring a maximum value of an interference envelope of each paired transmission interference optical path of the aperture pair array through the photoelectric conversion and data acquisition unit, then determining a zero optical path difference position of each paired transmission interference optical path in each aperture pair array of the solar imager, and arranging the fast phase scanning modulation and compensation module near the zero optical path difference position of each paired transmission interference optical path of each aperture pair array;
S2, activating the fast phase scanning modulation and compensation module and the photoelectric conversion and data acquisition unit, scanning through vicinity of the zero optical path difference of each paired transmission interference optical path through the fast phase scanning modulation and compensation module of the solar imager, and recording cross-correlation intensity interference data of two orthogonal polarized light information Ix and Iy of the solar light acquired by the integrated orthogonal polarization measurement device array through the photoelectric conversion and data acquisition unit; and
S3, filtering out direct current through the data processing and image reconstruction unit, calculating peak-to-valley values and means of cross-correlation intensity interference data of two orthogonal polarized light information Ix and Iy of solar light, obtaining contrast of cross-correlation intensities of a spatial frequency spectrum at two orthogonal polarization states, and reconstructing a solar high-spatial-resolution image through a phase retrieval and image reconstruction algorithm.

6. The method for operating the high-spatial-resolution solar imager based on optical interference according to claim 5, wherein the integrated orthogonal polarization measurement device array is located between the narrowband beam single-mode fiber transmission array and the photoelectric conversion and data acquisition unit, and the integrated orthogonal polarization measurement device array completes the contrast measurement of the cross-correlation intensities of two orthogonal polarized light information Ix and Iy of the solar light.
